(19) United States
(12) Patent Application Publication
(10) Pub. No.: US 2024/0132301 A1
(43) Pub. Date: Apr. 25, 2024

(54) Conveyor device for advancing articles and method for labelling articles

(71) Applicant: SIDEL PARTICIPATIONS, OCTEVILLE-SUR-MER (FR)

(72) Inventors: Stefano BERNINI, Mantova (IT); James CARMICHAEL, Mantova (IT)

(21) Appl. No.: 17/768,839

(22) PCT Filed: Oct. 16, 2019
(86) PCT No.: PCT/EP2019/078168

§ 371 Date: Apr. 12, 2022

(51) Int. Cl. B65G 47/84; B65C 9/04; B65G 17/00; B65G 17/32; B65G 23/30

(52) U.S. Cl. CPC B65G 47/848; B65C 9/04; B65G 17/002; B65G 17/323; B65G 23/30; B65G 17/46

(57) ABSTRACT

A conveyor device for advancing articles adapted to contain a pourable product and having an input station, at which the articles are fed to the conveyor device; an output station, at which the articles exit the conveyor device; a fixed endless track defining an endless path passing through the input station and the output station; and at least one article-holding device movably coupled to the track and configured to receive and support one article at a time and to advance the article along the endless path from the input station to the output station. The endless path comprises a rotation branch arranged downstream of the input station and upstream of the output station, relative to the direction of advancement of the articles along the endless path. Each article is rotatable about its longitudinal axis along the rotation branch by magnetic-inductive interaction between the article-holding device and the track.

### TECHNICAL FIELD

The present invention relates to a conveyor device for advancing articles adapted to contain a pourable product, preferably a pourable food product.

The present invention also relates to a method for labelling articles adapted to contain a pourable product, preferably a pourable food product.

### BACKGROUND ART

Plants for the handling and treating of articles, such as containers adapted to contain a pourable product, preferably a pourable food product, are known.

Such plants typically comprise a number of handling and/or treating units, each configured to perform a predetermined operation encompassed within a treating process of the above-mentioned articles.

For example, in case articles made of plastic material are to be treated, the plants usually comprise:
a blowing unit, or blower, configured to obtain plastic containers, such as bottles, starting from known preforms;
a filling unit configured to fill the containers with a predetermined quantity of pourable product;
a capping unit configured to apply a closure (i.e. a cap) to each container previously filled;
a labelling unit configured to apply labels onto containers; and
a series of transfer units and/or conveying units to transfer and/or advance the containers between each of, and within each of, the above units.

In particular, labelling units are known which generally comprise:
a conveyor device, usually a carousel rotatable about a vertical axis and configured to convey a plurality of successive articles along a predetermined arc-shaped horizontal path;
an input station, at which the articles to be labeled are fed to the carousel;
an output station, at which the labeled articles exit from the carousel; and
one or more labelling modules, peripherally arranged with respect to the carousel and configured to feed respective pluralities of labels to the carousel itself, at an application station, in order to apply such labels onto respective articles.

The configuration and operation of such labelling units are widespread and known in the art; therefore, they will not be described in detail hereinafter.

Basically, within the labelling unit the articles are, in use, rotated about their own axes while being advanced along the carousel, so as to ease the transfer of the labels from the labelling module to the carousel, and therefore so as to ease the application thereof onto the outer lateral surfaces of the articles themselves.

In particular, the carousel comprises a plurality of support plates, each one configured to receive and support a respective article along the arc-shaped horizontal path. The rotation of the articles is normally obtained by actuator means individually provided for each single support plate, such as stepper motors coupled to the relative support plates and configured to actuate the relative support plates, in order to rotate the articles.

Although being functionally valid, the known plants and labelling units are still open to further improvement, in particular as to improve their overall efficiency and simplify their structural architecture.

### DISCLOSURE OF INVENTION

It is therefore an object of the present invention to provide a conveyor device, which is designed to meet at least one of the above-mentioned needs in a straightforward and low-cost manner.

This object is achieved by a conveyor device as claimed in claim 1.

It is a further object of the present invention to provide a method for labelling articles, which is designed to meet at least one of the above-mentioned needs in a straightforward and low-cost manner.

This object is achieved by a method for labelling articles as claimed in claim 12.

### BRIEF DESCRIPTION OF THE DRAWINGS

Non-limiting embodiments of the present invention will be described by way of example with reference to the accompanying drawings, in which:

FIG. 1 is a schematic top view, with parts removed for clarity, of a labelling unit including a conveyor device according to a preferred embodiment of the present invention;

FIG. 2 is a larger-scale, partially sectioned perspective view, with parts removed for clarity, of a detail of the conveyor device of FIG. 1;

FIG. 3 is a larger-scale, partially sectioned side view, with parts removed for clarity, of a component of the conveyor device of FIG. 1;

FIG. 4 is a larger-scale, partially sectioned side view, with parts removed for clarity, of a component of a conveyor device according to a further preferred embodiment of the present invention; and

FIG. 5 is a larger-scale, partially sectioned side view, with parts removed for clarity, of a component of a conveyor device according to another preferred embodiment of the present invention.

### BEST MODE FOR CARRYING OUT THE INVENTION

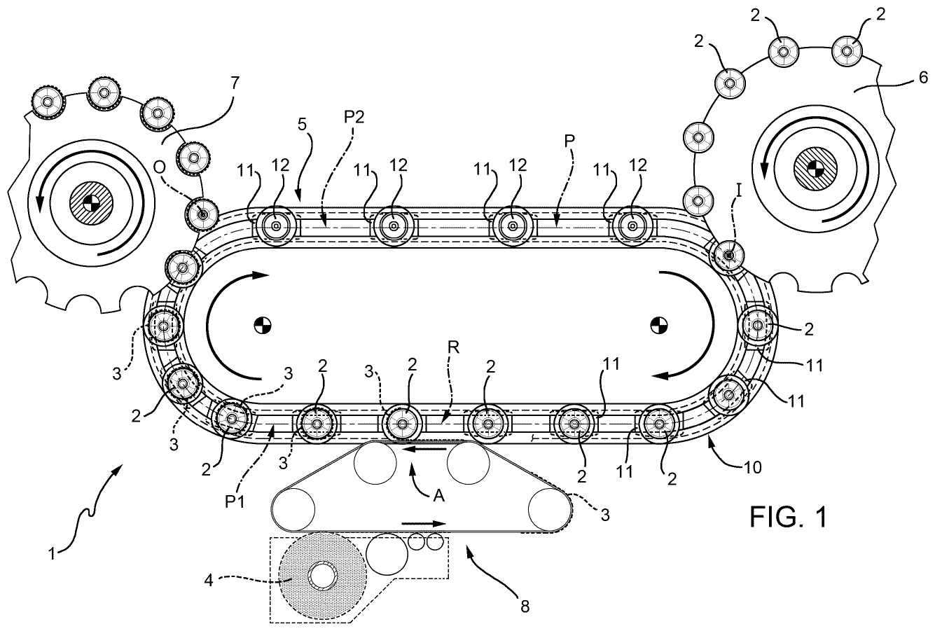

With reference to FIG. 1, number 1 indicates as a whole a handling unit for handling articles 2 adapted to contain a pourable product, preferably a pourable food product.

In detail, the handling unit 1 is configured to carry out at least one handling and/or treating operation onto such articles 2.

According to the specific preferred embodiment described and illustrated herein, unit 1 is a labelling unit configured to apply labels 3, obtained from a web 4 of labelling material, onto respective articles 2.

In the example shown, labels 3 are of the type known as “glue labels”, i.e. strips of labelling material having equal length cut from web 4 and then sprinkled with glue prior to their application onto articles 2.

Unit 1 essentially comprises:
a conveyor device 5 configured to advance a plurality of articles 2 along an endless path P;
an input device, in particular an input star wheel 6 configured to feed articles 2 to be labelled to conveyor device 5 at an input station I;
an output device, in particular an output star wheel 7 configured to receive labelled articles 2 from conveyor device 5 at an output station O; and
a labelling module 8 (only schematically shown in FIG. 1) arranged peripherally with respect to conveyor device 5, in particular with respect to endless path P in a position downstream of input station I and upstream of output station O, and configured to sequentially apply labels 3 to respective articles 2 at an application station A, according to a manner known and not described in detail.

In light of the above, conveyor device 5 is configured to advance articles 2 along part of endless path P, from input station I to output station O, passing through application station A. Therefore, endless path P passes substantially through input station I, application station A and output station O.

It is stated that the wording “endless” is intended to indicate herein a closed-loop configuration, for example an annular, oval, elliptical, circular or polygonal configuration.

Conveyor device 5 comprises:
a fixed endless track 10 defining, and therefore extending along, endless path P; and
a plurality of carts 11 movably coupled to track 10 so as to endlessly move, in use, along endless path P and configured to respectively carry articles 2 from input station I to output station O.

In detail, each cart 11 is slidingly coupled to track 10 so as to cyclically move along endless path P and is configured to receive one respective article 2 at input station I, support such article 2 along part of endless path P, through application station A and release article 2 at output station O.

In greater detail, each cart 11 comprises a support plate 12 configured to receive, retain and support one article 2 at a time. Conveniently, support plate 12 is arranged in an upper part of cart 11 and is shaped so as to receive a bottom portion of articles 2.

Once having released the relative article 2, each cart 11 is configured to move back from output station O towards input station I, at which it receives another article 2 to be labelled.

Hence, each cart 11 defines an article-holding device cyclically movable along endless path P.

According to this preferred embodiment shown, track 10 is substantially oval-shaped and has an operative branch P1, extending from input station I to output station O, and a return branch P2, extending from output station O to input station I, relatively to the direction of advancement of carts 11 and articles 2 along track 10.

Conveniently, carts 11 are controllable to move independently from one another along endless path P.

For this purpose, carts 11 are controllable along endless path P by means of a first magnetic-inductive interaction between track 10 and the carts 11 themselves.

For the sake of brevity, reference is made in the following to a single cart 11 configured to move along endless path P and to carry a relative article 2 along operative branch P1.

The structural and functional features described and illustrated hereinafter for such cart 11 and article 2 are applicable to each cart 11 of conveyor device 5 ant to each article 2 advanced by conveyor device 5.

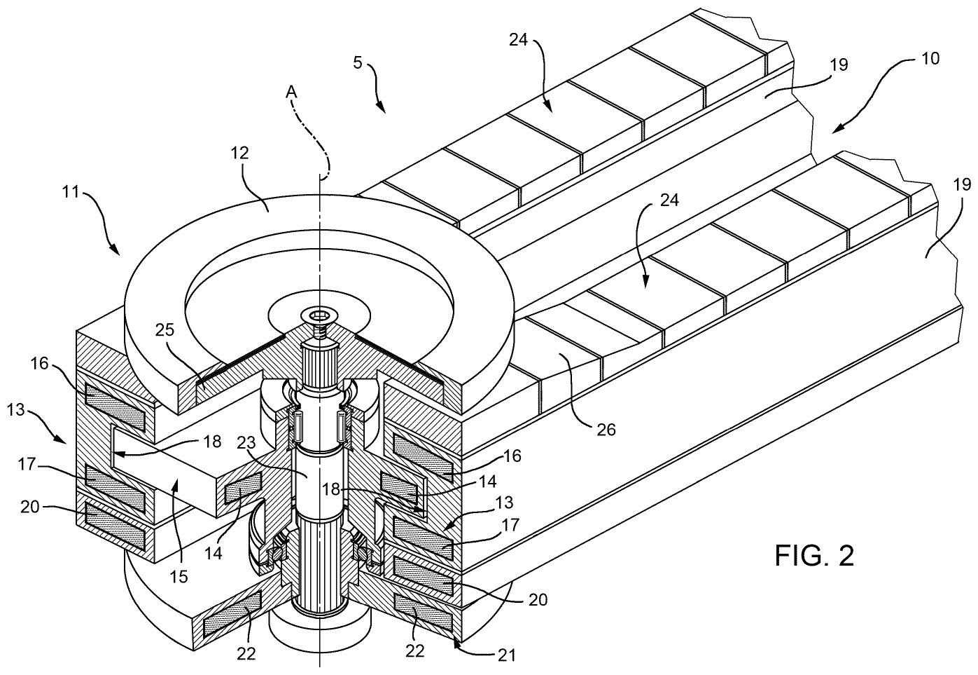

More specifically, as visible in FIG. 2, track 10 is provided with a plurality of individually-excitable solenoids 13 distributed along endless path P, in particular extending along the entire length of endless path P, and configured to be selectively energized with an electric current in order to produce a magnetic field.

It is stated that the wording “along endless path P” indicates herein either a direction along the endless path P itself or any direction substantially parallel to endless path P itself.

Preferably, solenoids 13 are arranged in a linear array; alternatively, they could be arranged in matrixes.

Furthermore, cart 11 carries, in particular comprises, at least one magnetic region, configured to be magnetically coupled with the solenoids 13, thereby defining the above-mentioned first magnetic-inductive interaction.

Preferably, the magnetic region is defined by at least one permanent magnet 14.

In greater detail, cart 11 comprises a core member 15, which defines the movable coupling between cart 11 and track 10; core member 15 superiorly carries support plate 12, relative to a longitudinal axis A of cart 11 substantially orthogonal to endless path P, and includes permanent magnet 14.

More specifically, support plate 12 is mechanically coupled to core member 15 and is carried by the latter along endless path P. Therefore, support plate 12 carries permanent magnet 14.

Track 10 is defined by two rails 19, each comprising one respective receiving seat 18 movably engaged, in use, by core member 15 and permanent magnet 14 and extending endlessly along endless path P.

In detail, each rail 19 is provided with a respective array of solenoids 13, positioned in correspondence of the relative receiving seat 18 so that such receiving seat 18 is configured to be invested by the magnetic field generated by solenoids 13 themselves.

In light of the above, the first magnetic-inductive interaction is defined between solenoids 13 and permanent magnet 14.

In another embodiment not shown, the whole core member 15 could define the magnetic region; for example, core member 15 may be wholly made in ferromagnetic material.

In practice, conveyor device 5 is of the linear motor type, the linear motor being defined by the first magnetic-inductive interaction between solenoids 13 and permanent magnet 14. In this way, the speed of carts 11 and the pitch between two successive carts 11 along track 10 can be varied at convenience.

According to a possible alternative embodiment not shown, track 10 could be provided with permanent magnets 14 and each cart 11 could be provided with solenoids 13.

In order to apply one label 3 onto article 2, article 2 is controllable to rotate about its longitudinal axis (not shown) along a rotation branch R of endless path P arranged downstream of input station I and upstream of output station O, and accordingly including application station A.

In practice, rotation branch R is positioned laterally to labelling module 8.

For this purpose, support plate 12 is controllable to rotate about axis A along rotation branch R, thereby imparting a rotation to the article 2 carried thereon, so as to ease the winding and, therefore, the application of label 3 onto the outer lateral surface of article 2.

Advantageously, support plate 12 is rotatable about axis A, and along rotation branch R, by means of a second magnetic-inductive interaction between cart 11 and track 10, distinct from the above-mentioned first magnetic-inductive interaction.

Hence, article 2 is rotatable about its own longitudinal axis by means of the second magnetic-inductive interaction.

In detail, track 10 is provided with a further plurality of individually-excitable solenoids 20 distributed along endless path P, in particular extending at least along rotating branch R, and configured to be selectively energized with an electric current in order to produce a magnetic field.

In greater detail, each rail 19 is provided with a corresponding plurality of solenoids 20, preferably arranged underneath solenoids 13.

Preferably, solenoids 20 are arranged in a linear array; alternatively, they could be arranged in matrixes.

Furthermore, cart 11 carries, in particular comprises, at least one further magnetic region, configured to be magnetically coupled with the solenoids 20, thereby defining the above-mentioned second magnetic-inductive interaction.

More specifically, cart 11 comprises a rotation member 21 carried by core member 15, in particular inferiorly carried by core member 15, relative to axis A, and including the further magnetic region.

In particular, rotation member 21 is mechanically coupled to core member 15, coaxially to axis A, and is carried in use by the latter along endless path P. Therefore, rotation member 21 is also cinematically coupled to support member 12.

In the example shown, core member 15 is coupled to support plate 12 and rotation member 21 by means of a shaft 23 and known suitable bearing assemblies.

Hence, support plate 12 is coupled to rotation member 21 by means of shaft 23.

Preferably, the magnetic region is defined by at least one permanent magnet 22.

Therefore, support plate 12 also carries permanent magnet 22.

In another embodiment not shown, the whole rotation member 21 could define the magnetic region; for example, rotation member 21 may be wholly made in ferromagnetic material.

In light of the above, the second magnetic-inductive interaction is defined between solenoids 20 and permanent magnet 22. Hence, permanent magnet 22 is configured to be magnetically coupled with the solenoids 20 to control the rotation of rotation member 21 and, therefore, the rotation of support plate 12 and article 2 about axis A and along rotation branch R.

Conveniently, solenoids 20 are controllable with a suitable programmable law of motion, which enables, in use, the control of a proper rotation of support plate 12.

According to another aspect of the present invention, cart 11 is movable along endless path P in a contactless manner with respect to track 10, by means of the first magnetic-inductive interaction between solenoids 13 and permanent magnet 14.

In particular, track 10 defines, in use, a contactless sliding guide for core member 15; i.e., core member 15 is configured to levitate relatively to track 10 during its movement along endless path 10.

More specifically, each rail 19 of track 10 comprises a first set 16 of solenoids 13 and a second set 17 of solenoids 13 facing one another along a direction parallel to axis A and arranged on opposite sides of the respective receiving seat 18. In other words, each receiving seat 18 is interposed between one first set 16 and one second set 17, relatively to a direction parallel to axis A.

In use, permanent magnet 14, which engages receiving seats 18 as stated above, is magnetically coupled with first sets 16 and second sets 17. Hence, receiving seats 18 define the above-mentioned contactless sliding guide for core member 15.

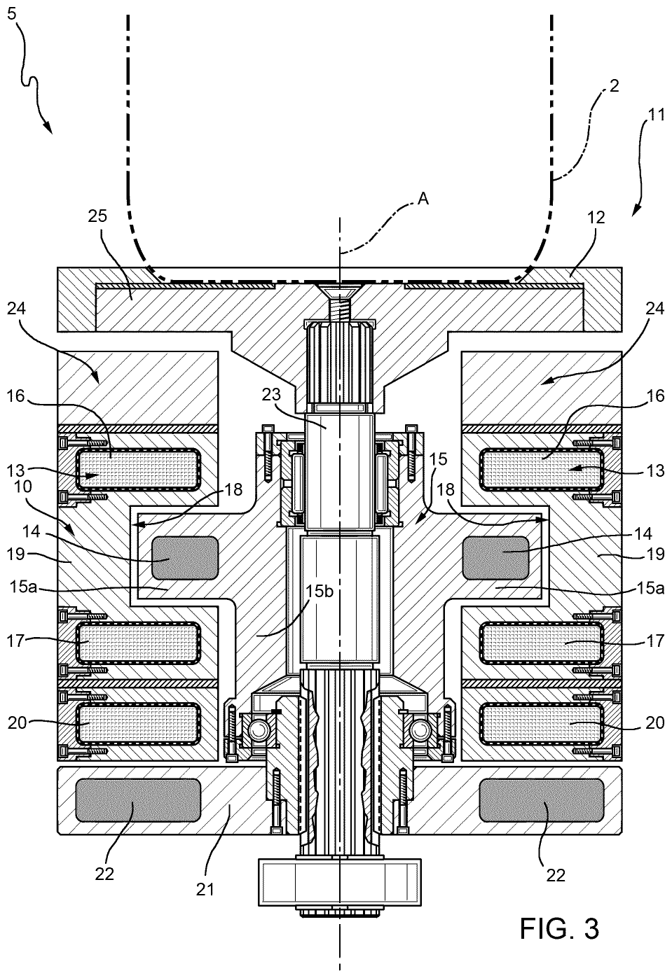

As visible in particular in FIG. 3, each rail 19 has a substantially “C”-shaped profile having one upper horizontal portion, one lower horizontal portion and a vertical connecting portion connecting the upper horizontal portion with the lower horizontal portion, preferably in a single piece. Each receiving seat 18 is axially delimited by the corresponding upper and lower portion and laterally delimited by the respective vertical portion.

Core member 15 comprises an hollow central portion 15b of axis A configured to receive shaft 23 and an elongated portion 15a radially protruding from central portion 15b, including permanent magnet 14 and configured to engage receiving seats 18.

In practice, elongated portion 15a levitates, in use, within receiving seat 18 while cart 11 moves along endless path P.

The contactless sliding of carts 11 with respect to track 10 allows a smooth movement of carts 11 and, combined with the magnetic-driven rotation of support plate 12, ensures the reduction of wear of the components involved.

According to this non-limiting embodiment shown, beside its rotation about axis A, support plate 12 is further movable along axis A. This movement may be useful especially at input station I and output station O, since the gripping means of input star wheel 6 and output star wheel 7, configured to release and receive articles 2, may be arranged at different heights with respect to the grip portions of articles 2 (for example, the neck portions of articles 2), when articles 2 are advanced by conveyor device 5.

Therefore, there may be the need to pick and release such articles 2 at different heights with respect to the height at which support plate 12 normally advances along endless path P, from input station I to output station O.

Accordingly, conveyor device 5 comprises cam means configured to control the axial movement of supporting plate 12.

In particular, cam means comprise:
a fixed cam member 24 fitted to track 10, extending along endless path P and comprising a first magnetic field generating portion; and
a cam follower 25 carried by support plate 12 and comprising a second magnetic field generating portion.

More in particular, conveyor device 5 comprises two cam members 24, each one mounted onto one respective rail 19. In practice, cam members 24 define the uppermost portion of track 10.

Cam follower 25 is defined by a lower portion of support plate 12 facing cam members 24.

In this specific example, each cam member 24 comprises first permanent magnets defining the first magnetic field generating portion. Similarly, cam follower 25 comprises at least one second permanent magnet defining the second magnetic field generating portion.

Opportunely, the first and second permanent magnets are arranged so as to face one another with corresponding magnetic poles having the same orientation, for example north-north or south-south.

In this way, a repulsive magnetic force is established between cam follower 25 and cam members 24, which allows to obtain the axial displacement of cam follower 25 and support plate 12 in a contactless manner.

Conveniently, each cam member 24 comprises inclined portions 26 (only one shown in FIG. 2) configured to determine, due to the above-mentioned repulsive force, an axial displacement of cam follower 25, due to the inclination of cam members 24 and, therefore, the axial displacement of support plate 12.

Inclined portions 26 are properly arranged upstream and downstream of input station I and upstream and downstream of output station O, so as to determine the ascending and descending axial movement of article 2 at said stations.

In other words, the second permanent magnet is magnetically couplable with the first permanent magnets to cause, in use, the axial movement of cam follower 25, while such movement of cam follower 25 controls an axial lift or descent of support plate 12.

The above configuration of cam means 24, 25 allows a smooth axial movement of support plate 12 and, combined with the magnetic-driven rotation of support plate 12 and with the contactless advancement of cart 11, ensures the reduction of wear of the components involved.

The operation of conveyor device 5 is described hereinafter with reference to a single cart 11 moving along track 10 and starting from a condition in which: cart 11 has received an article 2 to be labeled at input station I; and a label 3 to be applied onto such article 2 is being advanced by labelling module 8 along a label transfer path towards application station A.

In this condition, cart 11 advances article 2 along operative branch P1 and towards rotation branch R, by means of the first magnetic-inductive interaction. When cart 11 reaches rotation branch R, support plate 12 is rotated about axis A by means of the second magnetic-inductive interaction.

Article 2 is consequently rotated about its own axis and, when cart 11 reaches application station A (and label 3 reaches, at the same time, application station A), label 3 is wound and applied onto article 2.

Then, cart 11 advances towards output station O, at which support plate 12 is lifted by cam means 24, 25 and feeds the labelled article 2 to output star wheel 7.

At this point, support plate 12 axially moves towards its initial axial position and advances along return branch P2, until reaching again input station I and receiving another article 2 to be labelled.

The above operation is repeated for each article 2 to be labelled and for each cart 11 that may be present on conveyor device 5.

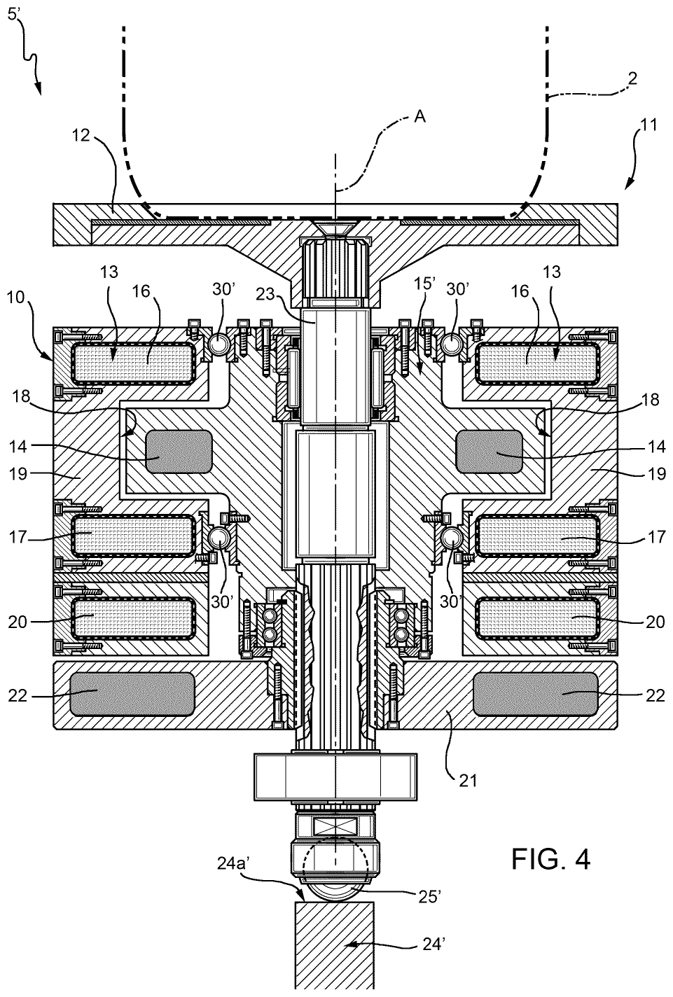

FIG. 4 shows a conveyor device 5′ according to an alternative embodiment of the present invention.

Since conveyor device 5′ is similar to conveyor device 5, the same references and numerals are used for equivalent or corresponding features.

In particular, conveyor device 5′ differs from conveyor device 5 in that cam means comprise:
a fixed cam member 24′ extending along endless path P and defining an endless cam track 24a′; and
a cam follower roller 25′ carried by support plate 12 and configured to cooperate in contact with cam member 24′ so as to slide along cam track 24a′.

In particular, roller 25′ is carried by shaft 23.

Accordingly, cam member 24′ comprises inclined portions (not shown) configured to control an axial movement of roller 25′ and, therefore, to cause an axial movement of support plate 12.

According to this embodiment, cart 11 of conveyor device 5′ comprises a core member 15′ configured to slide in a contact manner along track 10.

In particular, core member 15′ is slidably coupled to rails 19 by means of suitable roller bearings 30′.

In one embodiment not shown, conveyor device 5′ could comprise a core member 15 of the type described above, and therefore sliding along track 10 in a contactless manner.

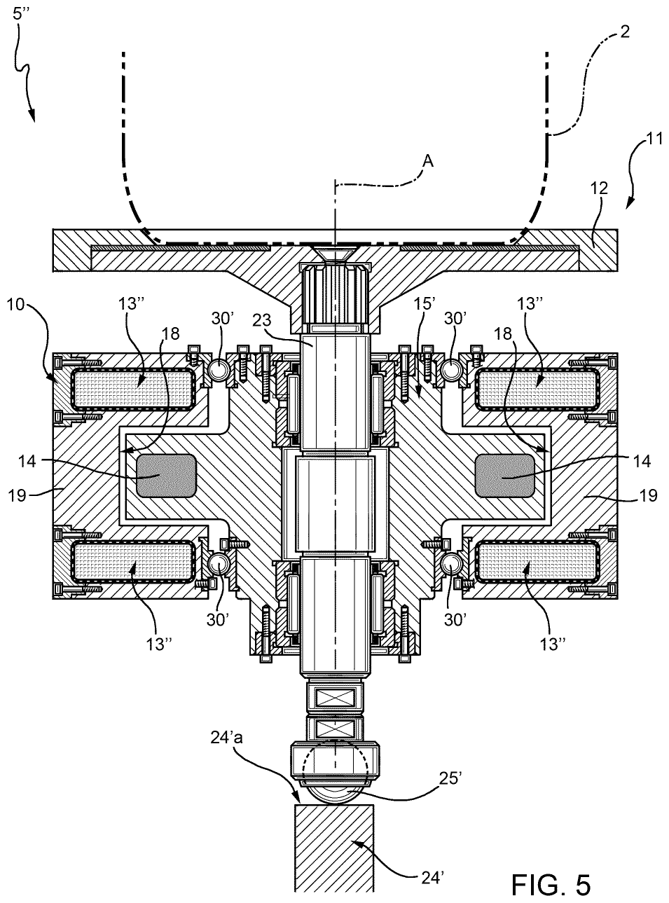

FIG. 5 shows a conveyor device 5″ according to a further embodiment of the present invention.

Since conveyor device 5″ is similar to conveyor device 5′, the same references and numerals are used for equivalent or corresponding features.

In particular, conveyor device 5″ differs from conveyor device 5′ by comprising solenoids 13″ which are configured to control both the advancement of cart 11 along endless path P and the rotation of support plate 12 about axis A.

More specifically, solenoids 13″ are magnetically couplable with permanent magnet 14 so as to define both the first magnetic-inductive interaction and the second magnetic-inductive interaction.

Accordingly, cart 11 of conveyor device 5″ is not provided with any rotation member or second permanent magnet.

According to this embodiment, cart 11 of conveyor device 5″ comprises a core member 15′ configured to slide in a contact manner along track 10.

In particular, core member 15′ is slidably coupled to rails 19 by means of suitable roller bearings 30′.

In one embodiment not shown, conveyor device 5″ could comprise a core member 15 of the above-mentioned type, and therefore sliding along track 10 in a contactless manner.

The advantages of conveyor device 5, 5′, 5″ according to the present invention will be clear from the foregoing description.

In particular, the above-described configuration allows to obtain the rotation of articles 2 in an efficient and simple manner, eliminating the need for dedicated actuators for each cart 11, thereby simplifying the architecture of the unit 1.

Furthermore, such rotation is obtained in a contactless manner, thereby improving the efficiency of conveyor device 5, 5′, 5″ and ensuring a reduction of wear of the components involved.

In addition, the contactless motion of carts 11 of conveyor device 5 along track 10 ensures a further reduction of wear of the components involved.

Finally, the contactless cam means 24, 25 of conveyor device 5 ensure a further reduction of wear of the components involved.

Clearly, changes may be made to conveyor device 5, 5′, 5″ as described herein without, however, departing from the scope of protection as defined in the accompanying claims.

In particular, conveyor device 5, 5′, 5″ could be configured to advance articles 2 between any two (or more) units of a line for packaging pourable products, wherein an operation which involves the rotation of articles 2 about their own axes has to be carried out onto the articles 2 themselves. For example, conveyor device 5, 5′, 5″ could be configured to advance articles 2 which have to be capped.

1. A conveyor device (5, 5′, 5″) for advancing articles (2) adapted to contain a pourable product, said conveyor device (5, 5′, 5″) comprising:
an input station (I), at which said articles (2) are fed to said conveyor device (5, 5′, 5″);
an output station (O), at which said articles (2) exit said conveyor device (5, 5′, 5″);
a fixed endless track (10) defining an endless path (P) passing through the input station (I) and the output station (0); and
at least one article-holding device (11) movably coupled to said track (10) and configured to receive and support one article (2) at a time and to advance said article (2) along said endless path (P) from the input station (I) to the output station (0);
said endless path (P) comprising a rotation branch (R) arranged downstream of said input station (I) and upstream of said output station (O), relative to the direction of advancement of said articles (2) along the endless path (P);
wherein each article (2) is rotatable about its own longitudinal axis along said rotation branch (R) by magnetic-inductive interaction between said article-holding device (11) and said track (10).

2. The conveyor device as claimed in claim 1, wherein the magnetic-inductive interaction is established, in use, between respective individually-excitable solenoids (20) and permanent magnets (22).

3. The conveyor device as claimed in claim 2, wherein said track (10) comprises a plurality of said individually-excitable solenoids (20), distributed along said rotation branch (R); and wherein said article-holding device (11) carries at least one said permanent magnet (22).

4. The conveyor device as claimed in claim 1, wherein said article-holding device (11) is controllable to move cyclically along said endless path (P) by means of a first magnetic-inductive interaction between said article-holding device (11) and said track (10);
and wherein said articles (2) are configured to be rotated along said rotation branch (R) by means of a second magnetic-inductive interaction between said article-holding device (11) and said track (10), distinct from said first magnetic-inductive interaction.

5. The conveyor device as claimed in claim 1, wherein said article-holding device (11) movably carries a support member (12) configured to receive and support one article (2) at a time and carrying a first permanent magnet (14) and a second permanent magnet (22); and
wherein said track (10) comprises:
a first plurality of individually-excitable solenoids (13) extending along said endless path (P) and configured to be magnetically coupled to said first permanent magnet (14) to control the advancement of said support member (12) along said endless path (P); and
a second plurality of individually-excitable solenoids (20) extending at least along said rotation branch (R) and configured to be magnetically coupled to said second permanent magnet (22) to control a rotation of said support member (12) when said support member (12) advances along said rotation branch (R).

6. The conveyor device as claimed in claim 5, wherein said article-holding device comprises a rotation member (21) cinematically coupled to said support member (12) and comprising said second permanent magnet (22); said rotation member (21) being rotatable about its own longitudinal axis (A) along said rotation branch (R) by means of interaction with said second plurality of individually-excitable solenoids (20).

7. The conveyor device as claimed in claim 5, wherein said article-holding device (11) is movable along said endless path (P) in a contactless manner with respect to said track (10) by means of magnetic-inductive interaction of the first plurality of individually-excitable solenoids (13) with the first permanent magnet (14).

8. The conveyor device as claimed in claim 7, wherein said article-holding device (11) comprises a movable member (15) defining, in use, the movable coupling between said article-holding device (11) and said track (10) and including said first permanent magnet (14);
said track (10) defining a contactless sliding guide for said movable member (15).

9. The conveyor device as claimed in claim 8, wherein said track comprises a first set (16) of said individually-excitable solenoids (13) and a second set (17) of said individually-excitable solenoids (13), said first set (16) facing said second set (17) along a direction substantially orthogonal to said endless path (P);
said track (10) further comprising an endless receiving seat (18) extending along said endless path (P) and interposed between said first set (16) and said second set (17) relative to said substantially orthogonal direction;
said movable member (15) engaging, in use, said receiving seat (18) so that said first permanent magnet (14) is magnetically coupled with said first set (16) and second set (17);
said receiving seat (18) defining said contactless sliding guide.

10. The conveyor device as claimed in any one of claims 5 to 9, wherein said support member (12) is further movable along a direction substantially orthogonal to said endless path (P); said conveyor device (5, 5′, 5″) comprising cam means (24, 25; 24′, 25′) configured to control the movement of said support member (12) along said substantially orthogonal direction.

11. The conveyor device as claimed in claim 10, wherein said cam means comprise:
a fixed cam member (24) fitted to said track (10), extending along said endless path (P) and comprising a first magnetic field generating portion; and
a cam follower (25) carried by said support member (12) and comprising a second magnetic field generating portion;
said second magnetic field generating portion being magnetically couplable with said first magnetic field generating portion to cause, in use, a movement of said cam follower (25) along said substantially orthogonal direction, said movement of said cam follower (25) controlling the movement of said support member (12) along said substantially orthogonal direction.

12. A method for labelling articles (2) adapted to contain a pourable product, the method comprising:
i) advancing at least one label (3) along a label transfer path;
ii) providing a fixed endless track (10) having a plurality of individually-excitable solenoids (20) and defining an endless path (P);
iii) advancing at least one article-holding device (11) comprising at least one permanent magnet (22) along said endless path (P);
iv) advancing at least one article (2) by means of said article-holding device (11) along at least part of said endless path (P), from an input station (I) of the track (10) to an output station (O) of the track (10);
v) advancing said article (2) along a rotation branch (R) of said endless path (P) arranged downstream of said input station (I) and upstream of said output station (O) and arranged adjacent to said label transfer path;
vi) rotating said article (2) about its own longitudinal axis (A) along said rotating branch (R), thereby determining the application of one respective label (3) onto said article (2);
wherein the rotating comprises:
vii) magnetically coupling said individually-excitable solenoids (20) with said permanent magnet (22).

13. The method as claimed in claim 12, wherein said track (10) comprises a further plurality of individually-excitable solenoids (13) and said article-holding device (11) comprises a further permanent magnet (14);
and wherein said advancing comprises:
viii) magnetically coupling said further individually-excitable solenoids (13) with said further permanent magnet (14).

14. The method as claimed in claim 13, wherein the advancing further comprises:
ix) moving said article-holding device (11) along said endless path (P) in a contactless manner with respect to said track (10) by means of magnetic-inductive interaction of said further individually-excitable solenoids (13) with said further permanent magnet (14).

15. The method as claimed in claim 14, wherein said further individually-excitable solenoids (13) comprise a first set (16) and a second set (17) of individually-excitable solenoids facing one another along a direction substantially orthogonal to said endless path (P);
said track (10) comprising an endless receiving seat (18) extending along said endless path (P) and interposed between said first set (16) and second set (17) relative to said substantially orthogonal direction;
the moving comprising:
x) engaging said receiving seat (18) with said article-holding device (11); and
x) controlling said article-holding device (11) to contactlessly slide with respect to said receiving seat (18).

16. The conveyor device as claimed 6, wherein said article-holding device (11) is movable along said endless path (P) in a contactless manner with respect to said track (10) by means of magnetic-inductive interaction of the first plurality of individually-excitable solenoids (13) with the first permanent magnet (14).
